(19) United States
(12) Patent Application Publication
(10) Pub. No.: US 2013/0322673 A1
(43) Pub. Date: Dec. 5, 2013

(54) GUITAR CASE

(71) Applicant: Toshimitsu Yuhara, Chikuma-shi (JP)

(72) Inventor: Toshimitsu Yuhara, Chikuma-shi (JP)

(21) Appl. No.: 13/983,633

(22) PCT Filed: Feb. 9, 2012
(86) PCT No.: PCT/JP2012/053588

§ 371 Date: Aug. 5, 2013

(30) Foreign Application Priority Data
Feb. 10, 2011 (JP) 2011-000684

(51) Int. Cl. H04R 1/02

(52) U.S. Cl. CPC H04R 1/028
USPC 381/334

(57) ABSTRACT

A guitar case has an amplifier unit and a speaker unit connected thereto integrally provided in a case main body. The speaker unit includes one or more speakers and is disposed in a panel of the case main body at a position which houses and faces a rear of a guitar neck portion. The guitar case includes: an adjustment operation unit disposed on the case main body close to the speaker unit, connected to the amplifier unit, and operated from outside; a connector unit disposed on the case main body, connected to an input unit of the amplifier unit, and including a microphone jack, a guitar microphone jack, and an external sound source jack; and a power supply unit supplying DC power to the amplifier unit. The amplifier unit is disposed adjacent to the speaker unit and connected to the speaker unit by connection wiring.

### TECHNICAL FIELD

The present invention relates to a guitar case where a case main body portion is integrally provided with at least an amplifier unit and a speaker unit connected to the amplifier unit.

### BACKGROUND ART

People referred to as “street musicians” give live performances in parks, on street corners, and the like using acoustic guitars. When doing so, although a loudspeaker apparatus including an amplifier unit, a speaker unit, and the like is required in addition to the guitar to amplify vocals and the sound of the guitar, when a loudspeaker apparatus is used, there is an overall increase in equipment and difficulty in setting up, which includes carrying and ensuring a power supply is available, and in some cases an operator of the equipment is also needed. There are also problems such as extra storage space being taken up during storage.

For this reason, the present applicant has already proposed an instrument case for solving the above problem in Patent Document 1. Such instrument case (guitar case) is a guitar case including a case main body portion that houses an instrument, where, by attaching at least an amplifier unit that processes a sound signal obtained from an instrument and a speaker unit connected to the output side of such amplifier unit to the case main body portion, the case main body portion also functions as a cabinet to which at least the amplifier unit and the speaker unit are attached. By doing so, a separate loudspeaker apparatus that accompanies an instrument such as a guitar becomes unnecessary, which makes it possible to half the trouble and exertion during transportation and also the storage space during storage. In particular, since the amplifier unit and the speaker unit are attached using empty spaces produced in the case main body portion due to curved portions and projecting portions of the instrument, it is fundamentally possible to use the shape of an existing case as it is and to avoid an increase in the size of a guitar case due to incorporation of the amplifier unit and the speaker unit.

### PRIOR ART DOCUMENTS

### Patent Documents

Patent Document 1: Japanese Laid-Open Patent Publication No. 2002-287745

### SUMMARY OF THE INVENTION

### Technical Problem to be Solved

The guitar case (instrument case) according to Patent Document 1 described above has the following issue to be solved. First, the guitar case according to Patent Document 1 cannot be said to be desirable from the viewpoint of applicability since the speaker unit is disposed in a space formed between the concave portions on both side surfaces of a guitar body. That is, for a guitar case, in many cases sufficient space is not formed by such concave portions of a guitar body and it is not uncommon for sufficient space for disposing a speaker unit not to be available. For this reason, there are many cases where application to an existing guitar case in particular is not possible, resulting in difficulties regarding applicability.

Secondly, since the position of the speaker unit is located toward the bottom and such position is specified by the shape of the guitar, and also sufficient space for disposing an amplifier unit is not available near the speaker unit, there is a fall in design freedom regarding the overall layout including both the amplifier unit and the speaker unit and the wiring that connects the amplifier unit and the speaker unit increases in length.

It is an object of the present invention to provide a guitar case that solves the above issues with the background art.

### Means for Solving the Problem

To solve the issues described above, a guitar case 1, where at least an amplifier unit 3 and a speaker unit 4 connected to an output unit 3e of the amplifier unit 3 are integrally provided in a case main body portion 2, is configured to comprise: the speaker unit 4, which includes one or two or more speakers 4a, 4b disposed in a panel portion 2n of the case main body portion 2 in which a neck portion Gn of a guitar G is housed and which faces a rear surface Gnr of the neck portion Gn; an adjustment operation unit 5, which is disposed on the case main body portion 2 at a position in the vicinity of the speaker unit 4, is connected to the amplifier unit 3, and is capable of being operated from at least an outside; a connector unit 6, which is disposed on the case main body portion 2, is connected to an input unit 3i of the amplifier unit 3, and includes a microphone jack 6a . . . to which at least a microphone Ma . . . can be connected; and a power supply unit 7 that supplies DC power to the amplifier unit 3.

In this case, according to a preferred aspect of the present disclosure, the connector unit 6 may include: one or two or more of an audio microphone jack 6a, a guitar microphone jack 6b, and an external sound source input jack 6c; and an external output terminal 6d that outputs a processed signal produced by processing an input signal. Also, the power supply unit 7 may include one or two or more of a cell, a battery 7a1 . . . (7b1 . . . ), a solar cell, and an input connector 6p for an external power supply. Further, a folding stand 8 for erecting the case main body portion 2 may be provided on the case main body portion 2.

### Effect of the Invention

With the guitar case 1 according to the present disclosure with the configuration described above, the following notable effects are achieved.

(1) Since the speaker unit 4 which includes one or two or more speakers 4a, 4b disposed in the panel unit 2n of the case main body portion 2 in which a neck portion Gn of a guitar G is housed and which faces a rear surface Gnr of the neck portion Gn is disposed, it is possible to easily apply the present disclosure even to an existing guitar case, which makes it possible to increase applicability. In particular, for the guitar case 1 that houses an acoustic guitar G, since voids are likely to be produced due to the construction of the guitar G, the present disclosure can be easily and reliably applied.
(2) When the guitar case 1 is erected, it is possible to set the position of the speaker unit 4 at a comparatively high position and to arbitrarily select such position (height). In addition, there is increased design freedom for laying out the amplifier unit 3 and the speaker unit 4, such as easily ensuring enough space to dispose the amplifier unit 3, and by disposing the amplifier unit 3 and the speaker unit 4 at adjacent positions, it is possible to shorten the wiring connecting the amplifier unit 3 and the speaker unit 4.
(3) According to a preferred aspect, by providing one or two or more of the audio microphone jack 6a, the guitar microphone jack 6b, and the external sound source input jack 6c on the connector unit 6, and also providing the external output terminal 6d that outputs a processed signal produced by processing an input signal, since it is possible to amplify and output both the guitar sound and audio (vocals), it is possible to realize an optimal live performance and the like by setting a relative volume balance between the guitar sound and the audio. By carrying out an adjustment process and mixing process on input signals from the audio microphone jack 6a, the guitar microphone jack 6b, and the external sound source input jack 6c and outputting from the external output terminal 6d, it is possible to function as a compact mixer, with use as a monitor when performing on a large stage also being possible. In such case in particular, the performer can obtain a favorable monitoring sound by carrying out adjusting and mixing without relying on a sound engineer.
(4) If, according to a preferred aspect, the power supply unit 7 also includes at least one or two or more of a cell, a battery 7a1 . . . (7b1 . . . ), a solar cell, and an input jack 6p for an external power supply, it is possible to select a power supply that suits the usage location or the like and to reliably ensure that a suitable power supply is available.
(5) If, according to a preferred aspect, a folding stand 8 for erecting the case main body portion 2 is provided on the case main body portion 2, it is possible to erect the case main body portion 2 using both the folding stand 8 and the case main body portion 2, which means that it is possible to easily and stably erect the case main body portion 2 at an arbitrary angle.

### BRIEF DESCRIPTION OF THE DRAWINGS

FIG. 1 is a front view showing the external appearance of a guitar case according to a preferred embodiment of the present disclosure.

FIG. 2 is a side view showing the external appearance of the guitar case.

FIG. 3 is a side cross-sectional view of the guitar case.

FIG. 4 is a block circuit diagram of an electrical system disposed in the guitar case.

FIG. 5 is a side view showing a state where the guitar case is erected using a folding stand.

FIG. 6 is a diagram useful in explaining a usage state of the guitar case.

### BEST MODE FOR CARRYING OUT THE INVENTION

Preferred embodiments of the present invention will now be described in detail with reference to the drawings.

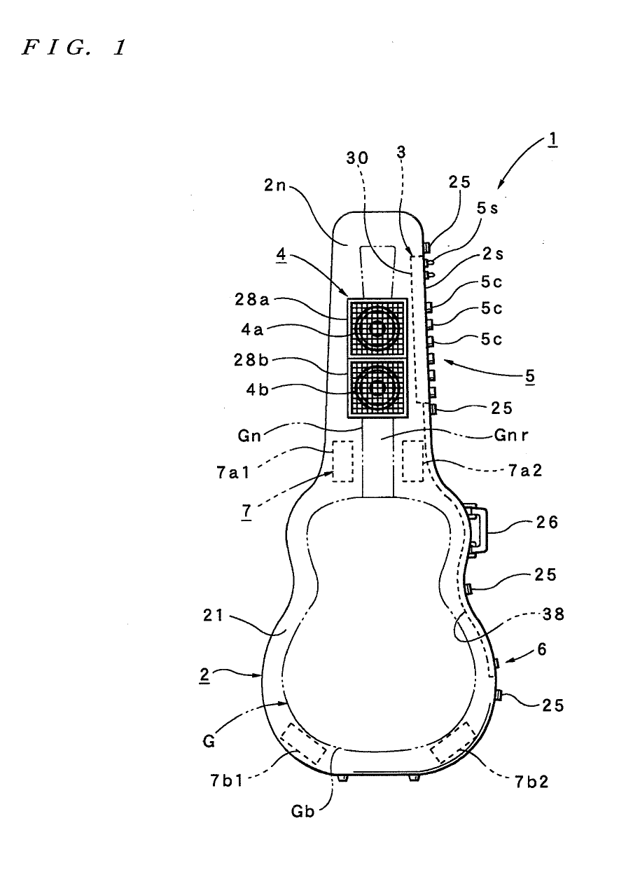

First, the configuration of a guitar case 1 according to the present embodiment will be described with reference to FIGS. 1 to 4.

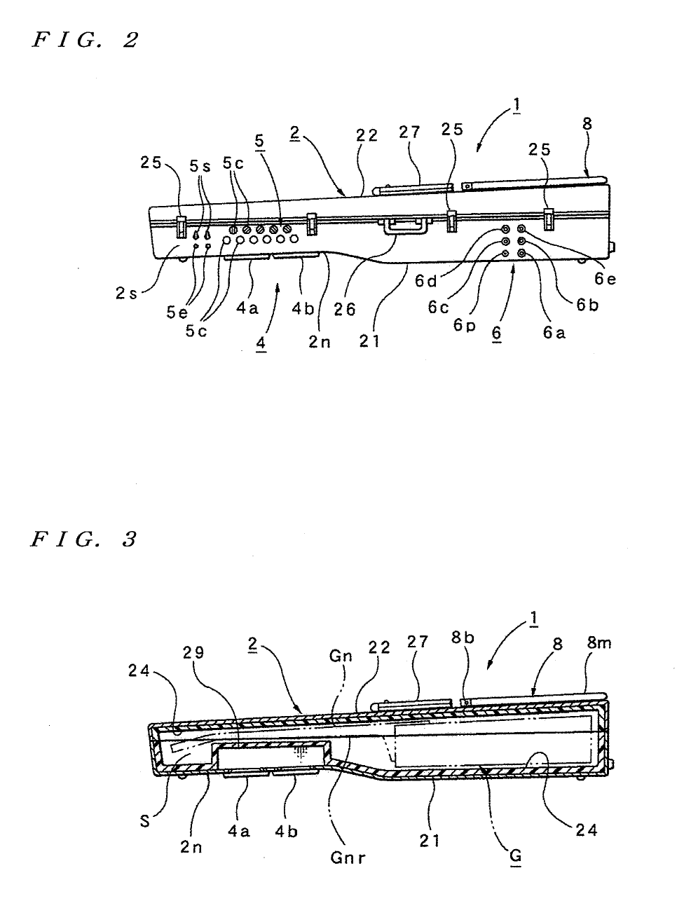

The guitar case 1 includes a case main body portion 2 that houses a guitar G. The illustrated guitar G is an acoustic guitar. As shown in FIG. 2, the case main body portion 2 includes a housing case portion 21 and a cover portion 22 that opens and closes the housing case portion 21 via hinge portions, with the housing case portion 21 and the cover portion 22 both being constructed using a rigid material such as plastic as a hard case. Also, as shown in FIG. 3, substantially the entire inner surface of the housing case portion 21 and the cover portion 22 is covered with a protective material 24 . . . , such as a cushion material. Note that on the case main body portion 2, 25 . . . denotes a plurality (in the illustrated example, four) of locking keys and 26 is a handle. In this way, the fundamental configuration of the case main body portion 2 is the same as a well-known guitar case. In addition, 27 denotes a pocket capable of housing replacement strings and the like and, although not illustrated, other necessary functional components, such as hooks for a shoulder strap, are also provided.

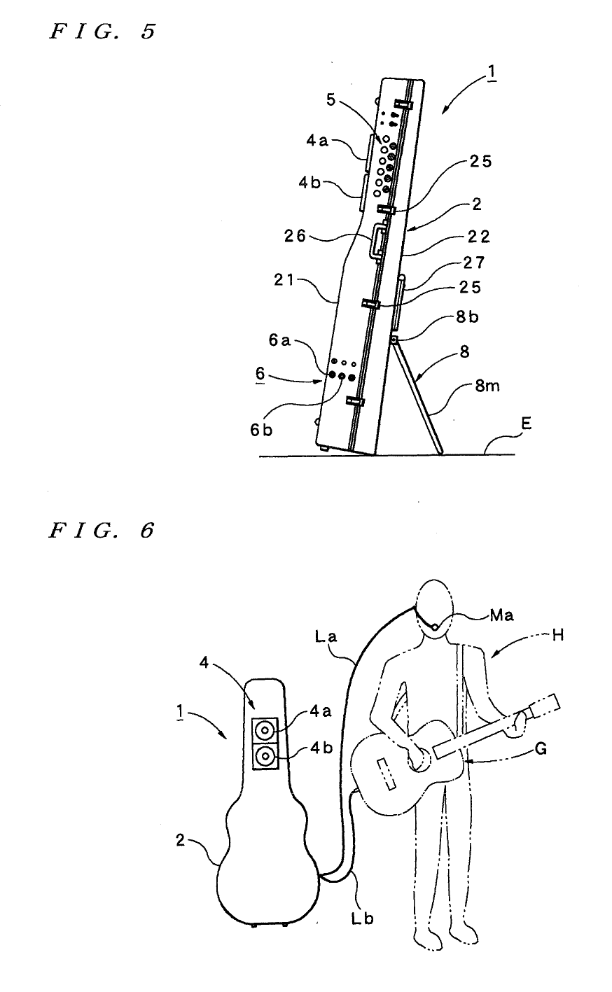

On the other hand, a folding stand 8 for erecting the case main body portion 2 is provided on the rear surface of the case main body portion 2, that is, on the outer surface of the cover portion 22. As shown in FIG. 3, the folding stand 8 is made up of a stand main body portion 8m and a bracket portion 8b that rotatably supports an upper end of the stand main body portion 8m. As shown in FIG. 5, during use, it is possible to open the stand main body portion 8m to a predetermined angle with respect to the outer surface of the cover portion 22 to erect the case main body portion 2 and when not in use, as shown in FIG. 2, to fold up the stand main body portion 8m so as to lie on the outer surface of the cover portion 22. Note that the shape of the illustrated stand main body portion 8m is an inverted V shape when viewed from the rear. Also, as necessary, a configuration can be used where the position of the stand portion 12 is lockable at the use position and the not-in-use position. Since it is possible, by providing this folding stand 8, to erect the case main body portion 2 using both the folding stand 8 and the case main body portion 2, it is possible to easily and stably erect the case main body portion 2 at an arbitrary angle.

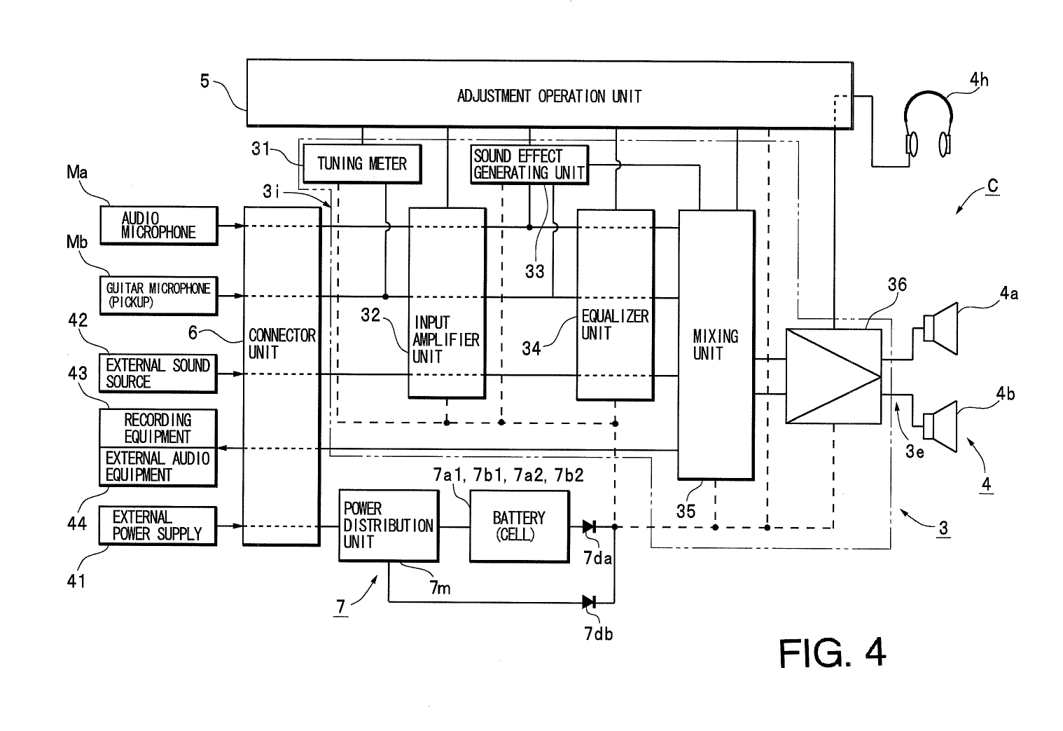

On the other hand, an electric loudspeaker circuit C shown in FIG. 4 is installed in the housing case portion 21. As shown in FIG. 4, the loudspeaker circuit C can be broadly divided into a connector unit 6, an amplifier unit 3, an adjustment operation unit 5, a speaker unit 4, and a power supply unit 7.

The speaker 4 is constructed using two speakers 4a, 4b, and the two speakers 4a, 4b are disposed on a panel portion 2n of the case main body portion 2 that faces a rear surface Gnr of a neck portion Gn of the guitar (acoustic guitar) G at a position where the neck portion Gn is housed. Since the neck portion Gn of a guitar (acoustic guitar) G normally extends from the vicinity of the sound hole portion of a body portion Gb, a narrow space S will be present in the case main body portion 2 on a rear surface Gnr side of the neck portion Gn. For this reason, the speakers 4a, 4b are attached using this space S. During attachment, two holes are opened in a row in the panel portion 2n, the speakers 4a, 4b are respectively housed in the two holes, and fixtures such as screws are used to attach the speakers 4a, 4b to the panel portion 2n from the outside. The front surface sides of the speakers 4a, 4b are covered by grills 28a, 28b that have a plurality of slits or small holes and the rear sides of the speakers 4a, 4b are covered by a box-like speaker protective cover 29. Note that the speaker protective cover 29 is attached to an inner side of the panel portion 2n. In addition, the adjustment operation unit 5 is equipped with a jack to which headphones 4h can be attached and detached.

The adjustment operation unit 5 that can be operated from at least the outside is provided on the case main body portion 2 in the vicinity of the speaker unit 4. In this case, if the panel portion 2n where the speaker unit 4 is disposed is set as the front surface, the adjustment operation unit 5 is disposed on a panel portion 2s positioned on a side surface. This adjustment operation unit 5 includes a plurality of adjustment knobs 5c . . . which for example include volume adjustment, tone adjustment (such as treble adjustment and bass adjustment), and sound effect adjustment, and also includes various switches 5s . . . including a change-over switch and a selecting switch and also various lamps 5e . . . .

A connector unit 6 is also disposed on the panel portion 2s which is positioned at the bottom when the case main body portion 2 is erected. Such connector unit 6 is provided with one or two or more of an audio microphone jack 6a, a guitar microphone jack 6b, and an external sound source input jack 6c, and is provided with an external output terminal 6d that outputs a processed signal produced by processing an input signal. In this case, as shown in FIG. 6, as examples, a hands-free type audio microphone Ma, a guitar microphone (pickup) incorporated in the guitar G and a microphone Mb (FIG. 4) can be connected to the microphone jack 6a . . . . By doing so, since it is possible to amplify and output both the guitar sound and audio (vocals), it is possible to realize an optimal live performance and the like by setting a relative volume balance between the guitar sound and the audio. On the other hand, it is possible to connect an external sound source 42 such as a CD player, a karaoke appliance or the like to the external sound source input jack 6c and to connect recording equipment 43 such as an IC recorder to the external output terminal 6d. By providing such connector unit 6, it is possible to carry out an adjustment process and mixing process on input signals from the audio microphone jack 6a, the guitar microphone jack 6b, and the external sound source input jack 6c and to output from the external output terminal 6d, thereby realizing a function as a compact mixer. Use as a monitor when performing on a large stage is also possible. In such case in particular, the performer can obtain a favorable monitoring sound by carrying out adjusting and mixing without relying on a sound engineer. Note that the connector unit 6 further includes an input jack 6p for an external power supply 41, a general-purpose input jack 6e, and the like.

In addition, a circuit box 30 in which the amplifier unit 3 is housed is attached to a rear surface side of the adjustment operation unit 5. Accordingly, as illustrated, the circuit box 30 is capable of covering the rear surface sides of both the amplifier unit 3 and the adjustment operation unit 5. As shown in FIG. 4, the amplifier unit 3 includes a tuning meter 31, an input amplifier unit 32, a sound effect generating unit 33, an equalizer unit 34, a mixing unit 35, and an output amplifier unit 36. The sound effect generating unit 33 includes a function for carrying out various signal processing such as generation of sound effects, such as conversion of a monaural signal to stereo (surround processing). The equalizer unit 34 has a tone adjustment function for various input signals and a feedback prevention function. The mixing unit 35 is capable of adjusting volume and mixing signals from the audio microphone Ma, a guitar microphone (pickup) Mb or external microphone Mb, an external sound source 42, and the sound effect generating unit 33. It is also possible to record the mixed signal using the recording equipment 43 or to send the mixed signal to external audio equipment 44. The output amplifier unit 36 has a function that carries out a signal amplifying process. In this case, wires for connecting the input unit 3i of the amplifier unit 3 and the connector unit 6 are laid out along the inner surface of the panel portion 2s, with such wiring being coved by a wiring cover 38. Note that since the wiring is placed along the inner surface of the panel unit 2s, the wiring does not get in the way. The speakers 4a, 4b are respectively connected to an output unit 3e of the amplifier unit 3. The amplifier unit 3 is also capable of being provided with audio signal processing circuits such as compressors, limiters, filters, gates, and expanders.

On the other hand, the power supply unit 7 that supplies DC power to the amplifier unit 3 is provided inside the case main body portion 2. The power supply unit 7 includes two batteries. In this case, the two batteries may be disposed at the positions 7a1, 7a2 in FIG. 1 or may be disposed at the positions 7b1, 7b2. A total of four batteries may be provided using both of such positions. Note that as the power supply unit 7, it is also possible to use a dry cell or a solar cell, or the external power supply 41 capable of inputting from the input jack 6p for an external power supply mentioned above. One or two or more of such may be used. In this way, if the power supply unit 7 includes at least one or two or more of cells, batteries 7a1 . . . (7b1 . . . ), a solar cell, and an input jack 6p for an external power supply, it is possible to select a power supply that suits the usage location or the like and to reliably ensure that a suitable power supply is available. In addition, in FIG. 4, 7m denotes a power distribution unit and a charging unit included in the power supply unit 7 and 7da, 7db denote backflow prevention diodes.

Next, the method of using and functions of the guitar case 1 according to the present embodiment will be described with reference to FIGS. 1 to 6.

First, the guitar case 1 can fundamentally be used as a normal guitar case that houses the guitar (acoustic guitar) G.

On the other hand, an empty case when the guitar G has been removed from the guitar case 1 is capable of being used as it is as a loudspeaker apparatus. During use, as shown in FIG. 5, the stand main body portion 8m is opened up to a predetermined angle with respect to the outer surface of the cover portion 22 to place the guitar case 1 in an erect state on the ground E or the like. Also, as shown in FIG. 6, the hands-free type audio microphone Ma set up by the performer H is connected via a connection cable La to the microphone jack 6a and the guitar microphone Mb incorporated in the guitar G is connected via a connection cable Lb to the microphone jack 6b.

By carrying out necessary adjustments using the adjustment operation unit 5, such as volume adjustment, tone adjustment (treble adjustment, bass adjustment), sound effect adjustment, and balance adjustment, it is also possible to carry out a live performance using the guitar case 1 as a loudspeaker apparatus.

In this way, with the guitar case 1 according to the present embodiment, since the speaker unit 4 including one or two or more speakers 4a, 4b is disposed in the panel portion 2n of the case main body portion 2 in which the neck portion Gn of the guitar G is housed and which faces the rear surface Gnr of the neck portion Gn, it is possible to easily apply the present disclosure even to an existing guitar case, which makes it possible to increase applicability. In particular, with the guitar case 1 that houses an acoustic guitar G, since voids are likely to be produced due to the construction of the guitar G, the present disclosure can be easily and reliably applied. When the guitar case 1 is erected, it is possible to locate the positions of the speaker unit 4 at a comparatively high position and also possible to arbitrarily select such position (height). In addition, there is increased design freedom for laying out the amplifier unit 3 and the speaker unit 4, such as easily ensuring enough space to dispose the amplifier unit 3, and by disposing the amplifier unit 3 and the speaker unit 4 at adjacent positions, it is possible to shorten the wiring connecting the amplifier unit 3 and the speaker unit 4.

Although preferred embodiments of the present invention have been described above, the present disclosure is not limited to such embodiments and the details regarding configuration, shape, materials, amounts and the like may be arbitrarily changed, added to, or omitted in a range that does not depart from the scope of the present invention. As one example, since the case main body portion 2 is self-standing by itself, the folding stand 8 does not necessarily need to be provided. Also, a pocket capable of storing sheet music, small items, and the like may be provided on the outer surface of the case main body portion 2. Note that the expression “neck portion Gn” is a concept that also includes the head portion of a guitar.

### INDUSTRIAL APPLICABILITY

A guitar case according to the present invention houses a guitar such as an acoustic guitar and can be used when integrally providing a loudspeaker circuit in a case main body.

### NUMERICAL REFERENCES

1: guitar case, 2: case main body portion 2n: panel portion, 3: amplifier unit, 3i: input unit of amplifier unit, 3e: output unit of amplifier unit, 4: speaker unit, 4a: speaker, 4b: speaker, 5: adjustment operation unit, 6: connector unit, 6a: microphone jack (audio microphone jack), 6b: microphone jack (guitar microphone jack), 6c external sound source input jack, 6d: external output terminal, 7: power supply unit, 7a1 . . . : battery, 7b1 . . . : battery, 6p input jack of external power supply, 8: folding stand, G: guitar (acoustic guitar), Gn: neck portion, Gnr: rear surface of neck portion, Ma: microphone

1-4. (canceled)

5. A guitar case where at least an amplifier unit and a speaker unit connected to an output unit of the amplifier unit are integrally provided in a case main body portion,
wherein the speaker unit, which includes one or two or more speakers, is disposed in a panel portion of the case main body portion at a position in which a neck portion of a guitar is housed and which faces a rear surface of the neck portion,
the guitar case includes:
an adjustment operation unit, which is disposed on the case main body portion at a position in the vicinity of the speaker unit, is connected to the amplifier unit, and is capable of being operated from at least an outside;
a connector unit, which is disposed on the case main body portion, is connected to an input unit of the amplifier unit, and includes at least an audio microphone input jack, a guitar microphone (pickup) input jack, and an external sound source input jack; and
a power supply unit that supplies DC power to the amplifier unit, and
the amplifier unit is disposed at a position adjacent to the speaker unit and is connected to the speaker unit by connection wiring.

6. The guitar case according to claim 5,
wherein the connector unit includes one or two or more of an audio microphone input jack, a guitar microphone (pickup) input jack, and an external sound source input jack,
the connector unit is capable of adjusting, carrying out sound effect processing, and appropriately mixing and amplifying signals from the jacks, and
the connector unit further includes an external output terminal that outputs a signal after mixing.

7. The guitar case according to claim 5,
wherein the power supply unit includes one or two or more of a cell, a battery, a solar cell, and an input connector for an external power supply.

8. The guitar case according to claim 6,
wherein the power supply unit includes one or two or more of a cell, a battery, a solar cell, and an input connector for an external power supply.

9. The guitar case according to claim 5,
wherein a folding stand for erecting the case main body portion is provided on the case main body portion.

10. The guitar case according to claim 6,
wherein a folding stand for erecting the case main body portion is provided on the case main body portion.

11. The guitar case according to claim 7,
wherein a folding stand for erecting the case main body portion is provided on the case main body portion.

12. The guitar case according to claim 8,
wherein a folding stand for erecting the case main body portion is provided on the case main body portion.
